(19) United States
(12) Patent Application Publication
(10) Pub. No.: US 2013/0050831 A1
(43) Pub. Date: Feb. 28, 2013

(54) LIGHT GUIDE PLATE AND MANUFACTURING METHOD THEREOF

(71) Applicants: Chechang Hu, Shenzhen (CN); Jianfa Huang, Shenzhen (CN)

(72) Inventors: Chechang Hu, Shenzhen (CN); Jianfa Huang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/378,045

(22) PCT Filed: Aug. 30, 2011
(86) PCT No.: PCT/CN2011/079135

§ 371 Date: Dec. 13, 2011

(30) Foreign Application Priority Data
Aug. 24, 2011 (CN) 201110248273.4

(51) Int. Cl. G02B 5/02; G02B 6/10

(52) U.S. Cl. 359/599; 264/1.27

(57) ABSTRACT

The present invention provides a light guide plate and a manufacturing method thereof. The manufacturing method of the light guide plate mainly first forms a light guide plate body, and then forms a plurality of light-guide scattering portions in an interior of the light guide plate body, and the light-guide scattering portions are arranged according to a specified manner. The light-guide scattering portions can reduce chromatic aberration of the light guide plate, prevent dot mura and increase light emitting efficiency.

### FIELD OF THE INVENTION

The present invention relates to a light guide plate, and more particularly to a light guide plate capable of reducing chromatic aberration and enhancing light-emitting efficiency and a manufacturing method thereof.

### BACKGROUND OF THE INVENTION

Since a liquid crystal panel of a liquid crystal display device does not have a self-luminous function, the liquid crystal display device hence further requires a backlight module to provide a sufficient and uniformly distributed surface light source. Generally, backlight modules are classified as direct type or edge type, wherein a light guide plate is a key component for providing a uniform surface source for an edge type of backlight module. A light guide plate transports incident lights from a side of the light guide plate to a farther end of the light guide plate using a theory of total reflection.

In order to let the lights to uniformly travel out of a light-emitting surface of the light guide plate, a design for light guide plate is to mount ink dots on a surface of the light guide plate by printing. The ink dots are used to destroy the total reflection of the incident lights, and make the incident lights to scatter out from the light-emitting surface. Another light guide plate design is to form micro structures on the surface of the light guide plate and use the micro structures to destroy the total reflection of the incident lights.

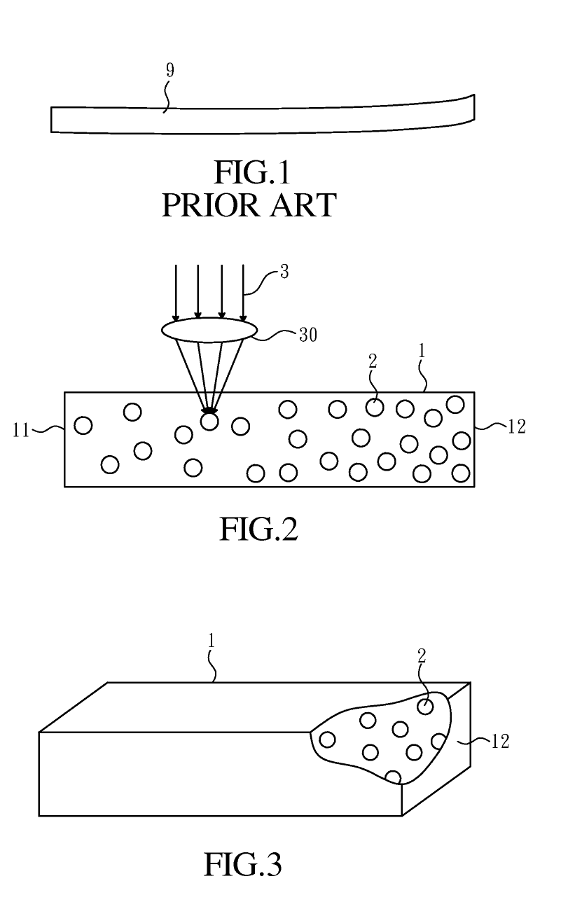

However, because the ink dots have a shortcoming of easily shedding off, and absorb blue light more strongly than absorb other visible lights, and thereby it causes serious chromatic aberration occurred on the light-emitting surface of the light guide plate and leads to an uneven chromatic aberration of backlight. Moreover, with reference to FIG. 1, FIG. 1 is a side view showing that a light guide plate is deformed after being through a drying process. A light guide plate 9 with printed ink dots has to pass through a drying process to dry the ink dots. But during the drying process, the structure of the light guide plate 9 may easily deform because of the heat. A deformed light guide plate structure may affect its optical functions.

Foregoing micro-structures may be easily scratched and then affect its optical functions. For large size backlight modules, using traditional injection molding devices to produce the micro-structures, it is evitable that problems about uniformity of the micro structures and the production quality may occur.

Hence, it is necessary to provide a light guide plate and a manufacturing method thereof to overcome the problems existing in the conventional technology.

### SUMMARY OF THE INVENTION

The present invention provides a light guide plate and a manufacturing method thereof so as to solve the problems existed in the traditional light guide plates with printed ink dots or with micro-structures.

A primary object of the invention is to provide a light guide plate including:

a light guide plate body having a first side and a second side, and the first side is used to receive incident lights, and the second side is opposite to the first side; and

a plurality of light-guide scattering portions formed in an interior of the light guide plate body and disposed between the first side and the second side.

In one embodiment of the present invention, lenses are used to focus laser beams at the interior of the light guide plate body and then the laser beams burn the interior of the light guide plate body to form the light-guide scattering portions.

In one embodiment of the present invention, the light-guide scattering portions are divided into a plurality of scattering columns, and the scattering columns are parallel to the first side and the second side of the light guide plate body, and the light-guide scattering portions disposed in the same scattering column are identical in size, and along a direction from the first side to the second side, the farther the light-guide scattering portions of the scattering column are away from the first side, the bigger size they have.

In one embodiment of the present invention, each of the light-guide scattering portions is identical to one another in size, and along a direction from the first side to the second side, the farther the light-guide scattering portions are away from the first side, the higher an arrangement density of the light-guide scattering portions in a unit area is.

In one embodiment of the present invention, material of the light guide plate body is selected from polymethacrylate or polycarbonate.

The present invention further provides a manufacturing method of a light guide plate having steps of:

forming a light guide plate body; and

forming a plurality of light-guide scattering portions in an interior of the light guide plate body.

In one embodiment of the present invention, lenses are used to focus laser beams at the interior of the light guide plate body and then the laser beams burn the interior of the light guide plate body to form the light-guide scattering portions.

In one embodiment of the present invention, the light guide plate body has a first side and a second side, and the first side is used to receive incident lights and the second side is opposite to the first side; and the light-guide scattering portions are divided into a plurality of scattering columns, and the scattering columns are parallel to the first side and the second side of the light guide plate body, and the light-guide scattering portions disposed in the same scattering column are equal in size, and along a direction from the first side to the second side, the farther the light-guide scattering portions of the scattering column are away from the first side, the bigger size they have.

In one embodiment of the present invention, the light guide plate body has a first side and a second side, and the first side is used to receive incident lights and the second side is opposite to the first side; and each of the light-guide scattering portions is identical to one another in size, and along a direction from the first side to the second side, the farther the light-guide scattering portions are away from the first side, the higher an arrangement density of the light-guide scattering portions in a unit area is.

In one embodiment of the present invention, material of the light guide plate body is selected from polymethacrylate or polycarbonate.

The present invention firstly forms a light guide plate body, and then burns an interior of the light guide plate body with laser beams to form a plurality of light-guide scattering portions, and the light-guide scattering portions are arranged according to a specified manner. The light-guide scattering portions formed by burning can reduce chromatic aberration of the light guide plate, prevent dot mura and increase light emitting efficiency.

DESCRIPTION OF THE DRAWINGS

FIG. 1 is a side view showing that a light guide plate is deformed after being through a drying process according to the prior art;

FIG. 2 is a side view in cross section of a first embodiment of a light guide plate in accordance with the present invention;

FIG. 3 is a perspective view of the first embodiment of the light guide plate in accordance with the present invention;

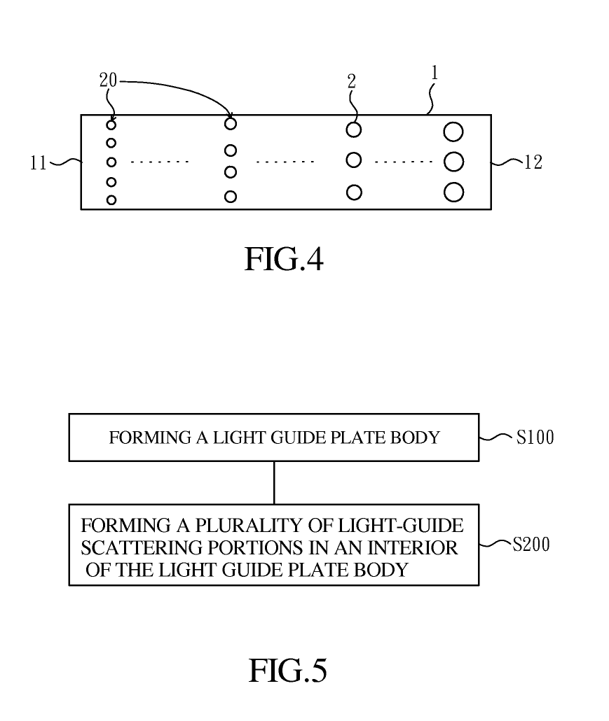

FIG. 4 is a side view in cross section of a second embodiment of the light guide plate in accordance with the present invention; and

FIG. 5 is a flow chart of a preferred embodiment of a manufacturing method of the light guide plate in accordance with the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

With reference to FIGS. 2 and 3, FIG. 2 is a side view in cross section of a first embodiment of a light guide plate in accordance with the present invention and FIG. 3 is a perspective view of the first embodiment of the light guide plate in accordance with the present invention. The light guide plate of the present invention mainly comprises a light guide plate body 1 and a plurality of light-guide scattering portions 2. The present invention is preferably applied to an edge type backlight module.

The light guide plate body 1 is preferably a component formed by injection molding, and material of the light guide plate body is preferably selected from polymethacrylate or polycarbonate, but is not limited thereto. The light guide plate body 1 has a first side 11 and a second side 12. The first side 11 is an incident side, which faces a light source and is used to receive incident lights. The second side 12 is opposite to the first side 11.

The light-guide scattering portions 2 are formed in an interior of the light guide plate body 1, and disposed between the first side 11 and the second side 12. The light-guide scattering portions 2 can reflect the lights that enter the light guide plate body 1 from the first side 11 to a light-emitting surface of the light guide plate body 1. As shown in FIG. 2, in this embodiment, the light-guide scattering portions 2 are preferably formed by a method that laser beams 3 are focused through lenses 30 at and burn the interior of the light guide plate body 1, but the light-guide scattering portions 2 are not limited to this forming method, for example, the light-guide scattering portions 2 can be mounted in the interior of the light guide plate body 1 by a method of introducing bubbles of gas during the process of forming the light guide plate body 1.

Furthermore, as shown in FIG. 2, in this embodiment, each of the light-guide scattering portions 2 is identical to one another in size, and along a direction from the first side 11 to the second side 12, the farther the light-guide scattering portions 2 are away from the first side 11, the higher an arrangement density of the light-guide scattering portions 2 in a unit area is. Hence, with the light-guide scattering portions 2 arranged at a higher intensity reflecting lights, quantity of reflected lights in the areas that are farther away from the incident light source may be close to the quantity of reflected lights in the areas that are nearer from the incident light source, and thereby making the lights of the light emitting surface to be evenly distributed.

Otherwise, with reference to FIG. 4, it is a side view in cross section of a second embodiment of the light guide plate in accordance with the present invention. The light-guide scattering portions 2 are divided into a plurality of scattering columns 20, and the scattering columns 20 are parallel to the first side 11 and the second side 12 of the light guide plate body 1, wherein the light-guide scattering portions 2 disposed in the same scattering column 20 are equal in size, and along a direction from the first side 11 to the second side 12, the farther the light-guide scattering portions 2 of the scattering column 20 are away from the first side 11, the bigger size they have. Therefore, with the light-guide scattering portions 2 with larger sizes reflecting lights, quantity of reflected lights in the areas that are farther away from the incident light source may be close to the quantity of reflected lights in the areas that are nearer from the incident light source, and thereby making the lights of the light emitting surface to be evenly distributed.

Arrangements related to the light-guide scattering portions 2 are not limited to the two abovementioned embodiments.

A manufacturing method of the light guide plate is referring to FIG. 5, and comprises steps of:

S100: forming a light guide plate body 1; and

S200: forming a plurality of light-guide scattering portions 2 in an interior of the light guide plate body 1. The same as the foregoing description, the light-guide scattering portions 2 are preferably formed by a method that laser beams 3 are focused through lenses 30 at and burn the interior of the light guide plate body 1, but the light-guide scattering portions 2 are not limited to this forming method, for example, the light-guide scattering portions 2 can be mounted in the interior of the light guide plate body 1 by a method of introducing bubbles of gas during the process of forming the light guide plate body 1.

With the foregoing description, comparing to the traditional light guide plate with printed ink dots that has shortcomings that ink may easily shed off and chromatic aberration may be worse, and to the light guide plate having micro-structures mounted on a surface thereof that may be easily scratched and then affect its optical functions, the light guide plate of the present invention that forms light-guide scattering portions in the interior of the light guide plate body by a method like using laser beams, can prevent dot mura from occurring, enhance light emitting efficiency and increase utilization efficiency of energy.

The present invention has been described with a preferred embodiment thereof and it is understood that many changes and modifications to the described embodiment can be carried out without departing from the scope and the spirit of the invention that is intended to be limited only by the appended claims.

1. A light guide plate, characterized in that: the light guide plate comprises:
a light guide plate body having a first side and a second side, and the first side is used to receive incident lights and the second side is opposite to the first side; and
a plurality of light-guide scattering portions formed in an interior of the light guide plate body and disposed between the first side and the second side; the light-guide scattering portions are formed by a method that lenses are used to focus laser beams at the interior of the light guide plate body and then the laser beams burn the interior of the light guide plate body to form the light-guide scattering portions; the light-guide scattering portions are divided into a plurality of scattering columns, and the scattering columns are parallel to the first side and the second side of the light guide plate body, and the light-guide scattering portions disposed in the same scattering column are identical in size, and along a direction from the first side to the second side, the farther the light-guide scattering portions of the scattering column are away from the first side, the bigger size they have.

2. A light guide plate, characterized in that: the light guide plate comprises:
a light guide plate body having a first side and a second side, and the first side is used to receive incident lights, and the second side is opposite to the first side; and
a plurality of light-guide scattering portions formed in an interior of the light guide plate body and disposed between the first side and the second side.

3. The light guide plate as claimed in claim 2, characterized in that: the light-guide scattering portions are formed by a method that lenses are used to focus laser beams at the interior of the light guide plate body and then the laser beams burn the interior of the light guide plate body to form the light-guide scattering portions.

4. The light guide plate as claimed in claim 2, characterized in that: the light-guide scattering portions are divided into a plurality of scattering columns, and the scattering columns are parallel to the first side and the second side of the light guide plate body, and the light-guide scattering portions disposed in the same scattering column are identical in size, and along a direction from the first side to the second side, the farther the light-guide scattering portions of the scattering column are away from the first side, the bigger size they have.

5. The light guide plate as claimed in claim 3, characterized in that: each of the light-guide scattering portions is identical to one another in size, and along a direction from the first side to the second side, the farther the light-guide scattering portions are away from the first side, the higher an arrangement density of the light-guide scattering portions in a unit area is.

6. The light guide plate as claimed in claim 2, characterized in that: material of the light guide plate body is selected from polymethacrylate or polycarbonate.

7. A manufacturing method of a light guide plate, characterized in that: the manufacturing method of the light guide plate comprises steps of:
forming a light guide plate body; and
forming a plurality of light-guide scattering portions in an interior of the light guide plate body.

8. The manufacturing method of the light guide plate as claimed in claim 7, characterized in that: the light-guide scattering portions are formed by a method that lenses are used to focus laser beams at the interior of the light guide plate body and then the laser beams burn the interior of the light guide plate body to form the light-guide scattering portions.

9. The manufacturing method of the light guide plate as claimed in claim 7, characterized in that:
the light guide plate body has a first side and a second side, and the first side is used to receive incident lights and the second side is opposite to the first side; and
the light-guide scattering portions are divided into a plurality of scattering columns, and the scattering columns are parallel to the first side and the second side of the light guide plate body, and the light-guide scattering portions disposed in the same scattering column are equal in size, and along a direction from the first side to the second side, the farther the light-guide scattering portions of the scattering column are away from the first side, the bigger size they have.

10. The manufacturing method of the light guide plate as claimed in claim 7, characterized in that:
the light guide plate body has a first side and a second side, and the first side is used to receive incident lights and the second side is opposite to the first side; and
each of the light-guide scattering portions is identical to one another in size, and along a direction from the first side to the second side, the farther the light-guide scattering portions are away from the first side, the higher an arrangement density of the light-guide scattering portions in a unit area is.

11. The manufacturing method of the light guide plate as claimed in claim 7, characterized in that: material of the light guide plate body is selected from polymethacrylate or polycarbonate.
